(19) United States
(12) Patent Application Publication
(10) Pub. No.: US 2024/0140475 A1
(43) Pub. Date: May 2, 2024

(54) Learning based Lane Centerline Estimation Using Surrounding Traffic Trajectories

(71) Applicant: GM Global Technology Operations LLC, Detroit, MI (US)

(72) Inventors: Shuqing Zeng, Sterling Heights, MI (US); Wei Tong, Troy, MI (US); Heng Zhou, Canton, MI (US); Upali P. Mudalige, Rochester Hills, MI (US); Reza Zarringhalam, Whitby (CA)

(21) Appl. No.: 18/050,642

(22) Filed: Oct. 28, 2022

(51) Int. Cl. B60W 60/00; G06V 20/56

(52) U.S. Cl. CPC B60W 60/001; G06V 20/588; B60W 2520/10; B60W 2520/12; B60W 2520/14; B60W 2552/53; B60W 2554/4041; B60W 2554/4045

(57) ABSTRACT

A method for determining a lane centerline includes detecting a remote vehicle ahead of a host vehicle includes determining a trajectory of the remote vehicle that is ahead of the host vehicle, extracting features of the trajectory of the remote vehicle that is ahead of the host vehicle to generate a trajectory feature vector, and classifying the trajectory of the remote vehicle that is ahead of the host vehicle using the trajectory feature vector to determine whether the trajectory of the remote vehicle includes a lane change. The method further includes determining a centerline of the current lane using the trajectory of the remote vehicle that does not include the lane change and commanding the host vehicle to move autonomously along the centerline of the current lane to maintain the host vehicle in the current lane.

### INTRODUCTION

The present disclosure relates to systems and methods for vehicle motion control. More particularly, the present disclosure describes methods and systems for learning-based centerline estimation using surrounding traffic trajectories.

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

Some autonomous vehicles include Advanced Drive Assistant System (ADAS) features, such as Traffic Jam Assist (TJA), adaptive cruise control (ACC), lake keeping assist (LKA), and lane management fusion ring (LMFR). ADAS features help drivers, for example, stay in their designated lane and remain a predetermined distance from the preceding vehicle (i.e., the vehicle in front of the host vehicle). Vehicles with ADAS features use sensors, such as cameras, to monitor lane markings and the preceding vehicle. However, when a vehicle drives towards a sharp curve, such as a road curve with a road radius that is greater than two hundred meters, it is challenging for the sensors (e.g., cameras) to detect lane markings and road edges. Also, vehicle cameras may not detect lane markings and road edges when the road is covered in snow. Consequently, the ADAS features may not be able to maintain the vehicle within its current lane when lane markings and road edges are not visible. It is therefore desirable to develop a system for maintaining an autonomous vehicle within its current lane even when the lane markings and the road edges are not visible.

### SUMMARY

The present disclosure describes a method for determining a lane centerline. In an aspect of the present disclosure, the method includes detecting a remote vehicle ahead of a host vehicle, determining a trajectory of the remote vehicle that is ahead of the host vehicle, extracting features of the trajectory of the remote vehicle that is ahead of the host vehicle to generate a trajectory feature vector, and classifying the trajectory of the remote vehicle that is ahead of the host vehicle using the trajectory feature vector to determine whether the trajectory of the remote vehicle includes a lane change. The lane change occurs when the remote vehicle moves from a current lane to an adjacent lane. The method further includes determining the lane centerline of the current lane using the trajectory of the remote vehicle that does not include the lane change in response to determining that the trajectory of the remote vehicle does not include the lane change. The method further includes commanding the host vehicle to move autonomously along the lane centerline of the current lane to maintain the host vehicle in the current lane. The method described in this paragraph improves autonomous vehicle technology by allowing a vehicle to autonomously maintain itself within a road lane even when the road edges and/or lane markings are not visible.

In an aspect of the present disclosure, classifying the trajectory of the remote vehicle that is ahead of the host vehicle includes using a convolutional neural network to determine whether the trajectory of the remote vehicle includes the lane change.

In an aspect of the present disclosure, the host vehicle defines a host-vehicle coordinate system. The method may further include determining, in real-time, a position of the remote vehicle that is ahead of the host vehicle. Further, the method may include transforming the position of the remote vehicle that is ahead of the host vehicle to a relative position with respect to the host-vehicle coordinate system.

In an aspect of the present disclosure, the trajectory includes a plurality of points. The plurality of points includes a first point and an end point. Extracting the features of the remote vehicle that is ahead of the host vehicle may include, but is not limited to, extracting: a relative lateral deviation between the end point and the first point of the trajectory of the remote vehicle that is ahead of the host vehicle; a relative longitudinal deviation between the end point and the first point of the trajectory of the remote vehicle that is ahead of the host vehicle; a yaw angle of the first point of the trajectory; a yaw angle of the end point of the trajectory; a maximal yaw of the trajectory; a minimal yaw of the trajectory; a standard deviation of the yaw angle in the trajectory; a relative lateral velocity of the remote vehicle at the first point of the trajectory; a relative longitudinal velocity of the first point of the trajectory; a relative lateral velocity of the end point of the trajectory; and a relative longitudinal velocity of the remote vehicle at the end point of the trajectory.

In an aspect of the present disclosure, the method includes selecting the trajectory that does not include the lane change based on a confidence score determined by the convolutional neural network.

In an aspect of the present disclosure, the method further includes fitting a polynomial curve to the plurality of points of the trajectory previously selected.

In an aspect of the present disclosure, determining the lane centerline of the current lane using the trajectory of the remote vehicle that is ahead of the host vehicle includes tracking the current lane using the polynomial curve.

In an aspect of the present disclosure, determining the lane centerline of the current lane includes tracking the current lane using V2V data received from the remote vehicle.

In an aspect of the present disclosure, the method further includes receiving current images and past images of the current lane.

In an aspect of the present disclosure, determining the lane centerline of the current lane includes tracking the current lane using the current images and the past images of the current lane.

The present disclosure also describes a tangible, non-transitory, machine-readable medium, including machine-readable instructions, that when executed by one or more processors, cause one or more processors to execute the method described above.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the presently disclosed system and method are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1 is a schematic diagram of a host vehicle including a system for learning-based centerline estimation using surrounding traffic trajectories;

FIG. 2 is a schematic diagram of a host vehicle surrounded by multiple remote vehicles; and

FIG. 3 is a flowchart of a method for learning-based centerline estimation using surrounding traffic trajectories.

### DETAILED DESCRIPTION

Reference will now be made in detail to several examples of the disclosure that are illustrated in accompanying drawings. Whenever possible, the same or similar reference numerals are used in the drawings and the description to refer to the same or like parts or steps.

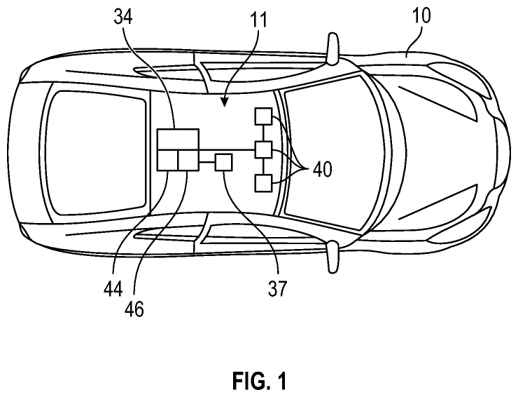

With reference to FIG. 1, a host vehicle 10 includes a system 11 for a for learning-based centerline estimation using surrounding traffic trajectories. While the system 11 is shown inside of the host vehicle 10, it is contemplated that some or all of the system 11 may be outside of the host vehicle 10. As a non-limiting example, the system 11 may be a cloud-based system in wireless communication with the host vehicle 10. Although the host vehicle 10 is shown as a sedan, it is envisioned that that host vehicle 10 may be another type of vehicle, such as a pickup truck, a coupe, a sport utility vehicle (SUVs), a recreational vehicle (RVs), etc. Irrespective of the type of vehicle 12, the host vehicle 10 may be an autonomous vehicle configured to drive autonomously.

The vehicle 10 includes a controller 34 and one or more sensors 40 in communication with the controller 34. The sensors 40 collect information and generate sensor data indicative of the collected information. As non-limiting examples, the sensors 40 may include Global Navigation Satellite System (GNSS) transceivers or receivers, yaw rate sensors, speed sensors, lidars, radars, ultrasonic sensors, and cameras, among others. The GNSS transceivers or receivers are configured to detect the location of the host vehicle 10 in the globe. The speed sensors are configured to detect the speed of the host vehicle 10. The yaw rate sensors are configured to determine the heading of the host vehicle 10. The cameras may have a field of view large enough to capture images in front, in the rear, and in the sides of the host vehicle 10. The ultrasonic sensor may detect dynamic objects, such as remote vehicles 54. The remote vehicles 54 may include one or more sensors 40 as described above with respect to the host vehicle 10.

The controller 34 includes at least one vehicle processor 44 and a non-transitory computer readable storage device or media 46. The vehicle processor 44 may be a custom made or commercially available processor, a central processing unit (CPU), a graphics processing unit (GPU), an auxiliary processor among several processors associated with the controller 34, a semiconductor-based microprocessor (in the form of a microchip or chip set), a macroprocessor, a combination thereof, or generally a device for executing instructions. The computer readable storage device or media 46 may include volatile and nonvolatile storage in read-only memory (ROM), random-access memory (RAM), and keep-alive memory (KAM), for example. KAM is a persistent or nonvolatile memory that may be used to store various operating variables while the processor 44 is powered down. The computer-readable storage device or media 46 of the controller 34 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 34 in controlling the host vehicle 10. The non-transitory computer readable storage device or media 46 may store map data and/or sensor data received from one of the sensors 40. The sensor data may include localization data received from the GNSS transceiver. The map data includes a navigation map. The remote vehicles 54 may include one or more controllers 34 as described above with respect to the host vehicle 10.

The host vehicle 10 may include one or more communication transceivers 37 in communication with the controller 34. Each of the communication transceivers 37 is configured to wirelessly communicate information to and from other remote entities, such as the remote vehicles 54, (through “V2V” communication), infrastructure (through “V2I” communication), remote systems at a remote call center (e.g., ON-STAR by GENERAL MOTORS, and/or personal electronic devices, such as a smart phone. The communication transceivers 37 may be configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards. Accordingly, the communication transceivers 37 may include one or more antennas for receiving and/or transmitting signals, such as vehicle-to-vehicle (V2V) communications and/or vehicle-to-infrastructure (V2I) communications. The communication transceivers 37 may be considered sensors 40 and/or sources of data. The remote vehicles 54 may include one or more communication transceivers 37 as described above with respect to the host vehicle 10.

The instructions may include one or more separate programs, each of which comprises an ordered listing of executable instructions for implementing logical functions. The instructions, when executed by the vehicle processor 44, receive and process signals from the sensors 40, perform logic, calculations, methods and/or algorithms for automatically controlling the components of the host vehicle 10, and generate control signals to the actuators to automatically control the components of the host vehicle 10 based on the logic, calculations, methods, and/or algorithms. Although a single controller 34 is shown in FIG. 1, the system 11 may include a plurality of controllers 34 that communicate over a suitable communication medium or a combination of communication mediums and that cooperate to process the sensor signals, perform logic, calculations, methods, and/or algorithms, and generate control signals to automatically control features of the system 11. In various embodiments, one or more instructions of the system controller 134 are embodied in the system 11. The non-transitory computer readable storage device or media 46 includes machine-readable instructions that when executed by the one or more processors 44, cause the processors 44 to execute the method 100 and processed described below.

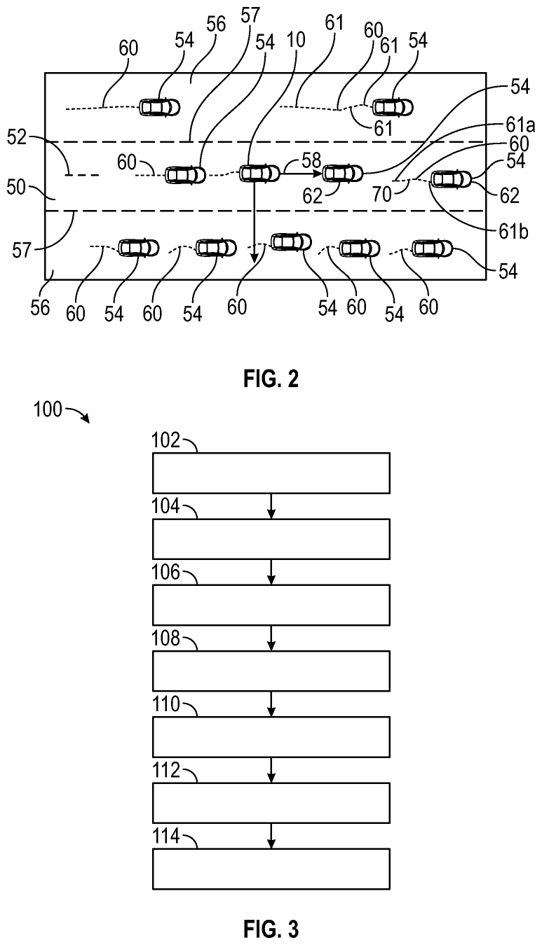

With reference to FIGS. 1 and 2, the system 11 is configured to estimate the lane centerline 52 of the lane where the host vehicle 10 is located (i.e., the current lane 50). In the present disclosure, the term “current lane” is the lane where the host vehicle 10 is located. Other lanes (i.e., adjacent lanes 56) may be directly adjacent to the current lane 50. The current lane 50 may be divided from the adjacent lanes 56 by lane markings 57. When driving along the current lane 50, the host vehicle 10 may be surrounded by one or more remote vehicles 54. Some of the remote vehicles 54 may be located ahead of the host vehicle 10 and in the current lane 50. The remote vehicles 54 that are located ahead of the host vehicle 10 and in the same lane as the host vehicle 10 (i.e., the current lane 50) are referred to herein as preceding vehicles 62. Each of the remote vehicles 54 may have the sensors 40, the communication transceivers 37, and the vehicle controller 34 described above with respect to the host vehicle 10. The host vehicle 10 defines a host-vehicle coordinate system 58 that moves in unison with the host vehicle 10. The sensors 40 of the host vehicle 10 are configured to detect the movement, location, velocity, heading, and other vehicle parameters of the remote vehicles 54 surrounding the host vehicle 10. The sensors 40 may then transmit sensor data (which is indicative of the movement, location, velocity, heading, and other vehicle parameters of the remote vehicles 54) to the controller 34. The controller 34 then uses the sensor data from the sensors 40 to determine the trajectories 60. Each remote vehicle 54 has a trajectory 60, and each trajectory may be expressed as a plurality of points 61. Each trajectory 60 includes first point 61a and an end point 61b tracked within a predetermined period of time.

FIG. 3 is a flowchart of a method 100 for learning-based centerline estimation using surrounding traffic trajectories. The method 100 begins at block 102. At block 102, the sensors 40 (e.g., cameras) of the host vehicle 10 detect objects, such as remote vehicles 54, surrounding the host vehicle 10. For example, the sensors 40 detect and collect data about the remote vehicles 54 surrounding the host vehicle 10, such as position, trajectory, yaw angle, lateral velocity, longitudinal velocity, among others. The data collected by the sensors 40 may be referred to as sensor data. The sensor data is then transmitted to the controller 34. Also, the controller 34 determines that the remote vehicles 54 are surrounding the host vehicle 10 using the sensor data. Then, the method 100 continues to block 104.

At block 104, the controller 34 receives the sensor data from one or more sensors 40 and transforms the global position of the objects (e.g., the remote vehicles 54) to a relative position relative to the host-vehicle coordinate system 58 defined by the host vehicle 10. In the other words, the controller 34 transforms the coordinates (i.e., the position) of each detected remote vehicles 54 to coordinates of the host-vehicle coordinate system 58 based on the motion of the host vehicle 10 using dead reckoning. Also, the controller 34 determines (e.g., estimates) the trajectories 60 of each of the remote vehicles 54 detected by the sensors 40 (e.g., camera, radar, and/or lidar) using the sensors data and/or data from V2V and/or V2I communications. The controller 34 may solely determine the trajectories 60 of the remote vehicles 54 that are ahead of the host vehicle 10 because those are the only trajectories 60 necessary to maintain the host vehicle 10 moving forward in the current lane 50. Then, the method 100 continues to block 106.

At block 106, the controller 34 extracts the features of each trajectory 60 determined at block 104. Further, the controller 34 generates a trajectory feature vector for each trajectory 60. As non-limiting examples, the controller 34 may extract the following features: a relative lateral deviation between the end point 61b and the first point 61b of the trajectory 60 of the remote vehicle 54, such as the remote vehicle 54 that is ahead of the host vehicle 10; a relative longitudinal deviation between the end point 61b and the first point 61b of the trajectory 60 of the remote vehicle 54; a yaw angle of the first point 61b of the trajectory 60; the yaw angle of the end point 61b of the trajectory 60; the maximal yaw of the trajectory 60; the minimal yaw of the trajectory 60; the standard deviation of the yaw angle in the trajectory 60; the relative lateral velocity of the remote vehicle 54 at the first point 61a of the trajectory 60; the relative longitudinal velocity of the remote vehicle 55 at the first point 61a of the trajectory 60; the relative lateral velocity of the end point 61b of the trajectory 60; and the relative longitudinal velocity of the remote vehicle 54 at the end point 61b of the trajectory 60. When the word “relative” is used with respect to the extracted features, it means that the extracted feature is measured relative to the host vehicle 10. Then, the method 100 continues to block 108.

At block 108, the controller 34 trains and executes a classifier using the trajectory feature vector to determine whether any of the previously determined trajectories 60 entails a lane change maneuver. As non-limiting examples, the classifier may be a support vector classifier or a neural network. The neural network may be a convolutional neural network. The classifier may classify the trajectories 60 into: (a) cruise on a straight road; (b) changes lanes on a straight road; (c) cruise on a curved road; and (d) change lane on a curved road. As a non-limiting example, the neural network may be a multilayer perceptron. In this case, the average of a plurality of trajectories 60 of the remote vehicles 54 located ahead of the host vehicle 10 serve as an input of the multilayer perceptron. The classifier outputs the trajectories 60 that do not entail any lane change maneuver (i.e., the no-lane change trajectories 70 in FIG. 2). The classifier also outputs confidence scores as to the confidence level of the identified no-lane change trajectories 70. Then, the method 100 continues to block 110.

At block 110, the controller 34 selects the no-lane change trajectories 70 based on the confidence score. For example, at block 110, the controller 34 selects the identified no-lane change trajectories that have a confidence score that is greater than a predetermined confidence threshold (i.e., the selected no-lane change trajectories 70). Then, the method 100 continues to block 112.

At block 112, the controller 34 performs a polynomial curve fitting of the selected no-lane change trajectories 70. In other words, a polynomial curve is fitted to the points 61 of the selected no-lane change trajectories 70. The fitted polynomial curve has a plurality of fitted lane parameters (e.g., slopes). Then, the method 100 continues to block 112.

At block 114, the controller 34 tracks the current lane 50 using the fitted lane parameters of the polynomial curve fitted to the points 61 of the selected no-lane change trajectories 70. The controller 34 may additionally integrate the current and past images received from the cameras, fitted lane parameters from the selected no-lane change trajectories 70 and/or data from V2V or V2I communications to determine (e.g., estimate) the lane centerline 52 of the current lane 50. Once the lane centerline 52 of the current lane 50 is determined, the controller 34 may control the movements of the host vehicle 10 using the lane centerline 52 of the current lane 50. For example, the controller 34 may command the host vehicle 10 to move autonomously along the lane centerline 52 of the current lane 50 to maintain the host vehicle 10 in the current lane 50.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the presently disclosed system and method that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

The drawings are in simplified form and are not to precise scale. For purposes of convenience and clarity only, directional terms such as top, bottom, left, right, up, over, above, below, beneath, rear, and front, may be used with respect to the drawings. These and similar directional terms are not to be construed to limit the scope of the disclosure in any manner.

Embodiments of the present disclosure are described herein. It is to be understood, however, that the disclosed embodiments are merely examples and other embodiments can take various and alternative forms. The figures are not necessarily to scale; some features could be exaggerated or minimized to display details of particular components. Therefore, specific structural and functional details disclosed herein are not to be interpreted as limiting, but merely as a representative basis for teaching one skilled in the art to variously employ the presently disclosed system and method. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Embodiments of the present disclosure may be described herein in terms of functional and/or logical block components and various processing steps. It should be appreciated that such block components may be realized by a number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with a number of systems, and that the systems described herein are merely exemplary embodiments of the present disclosure.

For the sake of brevity, techniques related to signal processing, data fusion, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that alternative or additional functional relationships or physical connections may be present in an embodiment of the present disclosure.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A method for determining a lane centerline, comprising:
detecting a remote vehicle ahead of a host vehicle;
determining a trajectory of the remote vehicle that is ahead of the host vehicle;
extracting features of the trajectory of the remote vehicle that is ahead of the host vehicle to generate a trajectory feature vector;
classifying the trajectory of the remote vehicle that is ahead of the host vehicle using the trajectory feature vector to determine whether the trajectory of the remote vehicle includes a lane change, wherein the lane change occurs when the remote vehicle moves from a current lane to an adjacent lane;
in response to determining that the trajectory of the remote vehicle does not include the lane change, determining the lane centerline of the current lane using the trajectory of the remote vehicle that does not include the lane change; and
commanding the host vehicle to move autonomously along the lane centerline of the current lane to maintain the host vehicle in the current lane.

2. The method of claim 1, wherein classifying the trajectory of the remote vehicle that is ahead of the host vehicle includes using a convolutional neural network to determine whether the trajectory of the remote vehicle includes the lane change.

3. The method of claim 2, wherein the host vehicle defines a host-vehicle coordinate system, the method further comprises determining, in real-time, a position of the remote vehicle that is ahead of the host vehicle, and the method further comprises transforming the position of the remote vehicle that is ahead of the host vehicle to a relative position with respect to the host-vehicle coordinate system.

4. The method of claim 3, wherein the trajectory includes a plurality of points, the plurality of points includes a first point and an end point, and extracting the features of the remote vehicle that is ahead of the host vehicle includes extracting: a relative lateral deviation between the end point and the first point of the trajectory of the remote vehicle that is ahead of the host vehicle; a relative longitudinal deviation between the end point and the first point of the trajectory of the remote vehicle that is ahead of the host vehicle; a yaw angle of the first point of the trajectory; the yaw angle of the end point of the trajectory; a maximal yaw of the trajectory; a minimal yaw of the trajectory; a standard deviation of the yaw angle in the trajectory; a relative lateral velocity of the remote vehicle at the first point of the trajectory; a relative longitudinal velocity of the first point of the trajectory; a relative lateral velocity of the end point of the trajectory; and a relative longitudinal velocity of the remote vehicle at the end point of the trajectory.

5. The method of claim 4, further comprising selecting the trajectory that does not include the lane change based on a confidence score determined by the convolutional neural network.

6. The method of claim 5, further comprising fitting a polynomial curve to the plurality of points of the trajectory previously selected.

7. The method of claim 6, wherein determining the lane centerline of the current lane using the trajectory of the remote vehicle that is ahead of the host vehicle includes tracking the current lane using the polynomial curve.

8. The method of claim 7, wherein determining the lane centerline of the current lane includes tracking the current lane using V2V data received from the remote vehicle.

9. The method of claim 8, further comprising receiving current images and past images of the current lane.

10. The method of claim 9, wherein determining the lane centerline of the current lane includes tracking the current lane using the current images and the past images of the current lane.

11. A tangible, non-transitory, machine-readable medium, comprising machine-readable instructions, that when executed by a processor, cause the processor to:
detect a remote vehicle ahead of a host vehicle;
determine a trajectory of the remote vehicle that is ahead of the host vehicle;
extract features of the trajectory of the remote vehicle that is ahead of the host vehicle to generate a trajectory feature vector;
classify the trajectory of the remote vehicle that is ahead of the host vehicle using the trajectory feature vector to determine whether the trajectory of the remote vehicle includes a lane change, wherein the lane change occurs when the remote vehicle moves from a current lane to an adjacent lane;
in response to determining that the trajectory of the remote vehicle does not include the lane change, determine a lane centerline of the current lane using the trajectory of the remote vehicle that does not include the lane change; and
command the host vehicle to move autonomously along the lane centerline of the current lane to maintain the host vehicle in the current lane.

12. The tangible, non-transitory, machine-readable medium of claim 11, wherein the tangible, non-transitory, machine-readable medium, further comprising machine-readable instructions, that when executed by the processor, causes the processor to:
use a convolutional neural network to determine whether the trajectory of the remote vehicle includes the lane change.

13. The tangible, non-transitory, machine-readable medium of claim 12, wherein the tangible, non-transitory, machine-readable medium, further comprising machine-readable instructions, that when executed by the processor, causes the processor to:
determine, in real-time, a position of the remote vehicle that is ahead of the host vehicle; and
transform the position of the remote vehicle to a relative position with respect to a host-vehicle coordinate system defined by the host vehicle.

14. The tangible, non-transitory, machine-readable medium of claim 13, wherein the trajectory includes a plurality of points, the plurality of points includes a first point and an end point, and the features include: a relative lateral deviation between the end point and the first point of the trajectory of the remote vehicle that is ahead of the host vehicle; a relative longitudinal deviation between the end point and the first point of the trajectory of the remote vehicle that is ahead of the host vehicle; a yaw angle of the first point of the trajectory; a yaw angle of the end point of the trajectory; a maximal yaw of the trajectory; a minimal yaw of the trajectory; a standard deviation of the yaw angle in the trajectory; a relative lateral velocity of the remote vehicle at the first point of the trajectory; a relative longitudinal velocity of the first point of the trajectory; a relative lateral velocity of the end point of the trajectory; and a relative longitudinal velocity of the remote vehicle at the end point of the trajectory.

15. The tangible, non-transitory, machine-readable medium of claim 14, wherein the tangible, non-transitory, machine-readable medium, further comprising machine-readable instructions, that when executed by the processor, causes the processor to:
select the trajectory of the remote vehicle that does not include the lane change based on a confidence score determined by the convolutional neural network.

16. The tangible, non-transitory, machine-readable medium of claim 15, wherein the tangible, non-transitory, machine-readable medium, further comprising machine-readable instructions, that when executed by the processor, causes the processor to:
fit a polynomial curve to the plurality of points of the trajectory after selecting the trajectory of the remote vehicle that does not include the lane change.

17. The tangible, non-transitory, machine-readable medium of claim 16, wherein the tangible, non-transitory, machine-readable medium, further comprising machine-readable instructions, that when executed by the processor, causes the processor to:
track the current lane using the polynomial curve.

18. The tangible, non-transitory, machine-readable medium of claim 17, wherein the tangible, non-transitory, machine-readable medium, further comprising machine-readable instructions, that when executed by the processor, causes the processor to:
track the lane using data from V2V communications received from the remote vehicle.

19. The tangible, non-transitory, machine-readable medium of claim 18, wherein the tangible, non-transitory, machine-readable medium, further comprising machine-readable instructions, that when executed by the processor, causes the processor to:
receive current images and past images of the current lane.

20. The tangible, non-transitory, machine-readable medium of claim 19, wherein the tangible, non-transitory, machine-readable medium, further comprising machine-readable instructions, that when executed by the processor, causes the processor to:
track the current lane using the current images and the past images of the current lane.
